(19) United States
(12) Patent Application Publication
(10) Pub. No.: US 2007/0284037 A1
(43) Pub. Date: Dec. 13, 2007

(54) EPOXY SECURED STOP COLLAR FOR CENTRALIZER

(76) Inventor: Jean Buytaert, Mineral Wells, TX (US)

Correspondence Address: STREETS & STEELE, 13831 NORTHWEST FREEWAY, SUITE 355, HOUSTON, TX, 77040, US

(21) Appl. No.: 11/422,696

(22) Filed: Jun. 7, 2006

(51) Int. Cl. B32B 37/00

(52) U.S. Cl. 156/294; 285/417

(57) ABSTRACT

A stop collar for securing a centralizer in place on a large diameter easing segment comprises a collar adapted for forming an annular chamber when received onto a casing segment. The stop collar is adapted for receiving and retaining a liquid gel epoxy adhesive in the annular chamber until the epoxy sets or cures to secure the stop collar in place on the casing.

### BACKGROUND

1. Field of the Invention

the present invention is directed to a stop collar for securing a centralizer on a pipe segment that is made up into a pipe string for installation into a drilled earthen borehole. Specifically, the present invention is directed to a sleeve that is adapted for being slidably received on and then secured to a pipe segment with an epoxy adhesive.

2. Description of Related Art

Casing is tubular pipe generally used to line a drilled earthen borehole to prevent collapse and to isolate the penetrated geologic formations. A tubular joint of casing is typically about 36 to 44 feet in length, and has threaded connections at each end to facilitate coupling to adjacent joints of casing to form an elongated casing string. Casing strings are made up as they are run into the borehole. After the desired length is achieved, the casing string is cemented into the borehole in the targeted interval. A predetermined volume of cement slurry is pumped from the surface down through the bore of the casing string and displaced from the bottom end of the casing string into the annular space between the casing string and the borehole.

It is important that the casing string be positioned as closely as possible to the center of the borehole prior to introducing cement slurry in order to promote uniform circumferential cement slurry placement around the casing string to reinforce the casing string, isolate the casing from corrosive formation fluids and prevent unwanted fluid flow between penetrated geologic formations. Centralizers of various types, such as bow spring centralizers and solid (rigid) centralizers, are used to center casing in the borehole and to provide the desired “stand-off” of the casing from the wall of the borehole.

As shown in FIG. 1, a centralizer 2 has a plurality of ribs 4 that provide stand-off. The stop collar 6 are adapted for being slidably received onto a pipe segment 7. The separation 8 between the opposed stop collars 6 depends on the extent of movement desired for the centralizer. In a solid centralizer like the one shown in FIG. 1, the separation of the stop collars is generally fixed. The rib 4 projects radially outwardly away from the center bore of the pipe segment 7 to provide desirable casing stand-off between the pipe and the wall of the borehole. In modern wells having intervals that are horizontal or substantially non-vertical, solid centralizers may be preferred to provide desired stand-off, and the stop collar of the present invention is useful for securing these centralizers.

Centralizers are generally secured at selected intervals along the length of the casing so that the centralizer ribs project radially outwardly therefrom to provide the desired casing stand-off. It is very important to secure the centralizers to the casing string at the selected positions along the length of the casing string and to prevent sliding of the centralizer along the casing string during casing installation. Sliding of the centralizers results in some intervals having insufficient stand-off between the casing string and the borehole, with resulting poor cement placement in the annulus and possible well failure.

A stop collar is a sleeve that is slidably received on and secured to the casing string to prevent unwanted movement of the centralizer along the length of the casing string. A stop collar may be slidable received on the pipe segment between the stop collars 6 of the centralizers so that one stop collar can engage the centralizer 2, depending on the direction of movement of the centralizer. Upon movement of the centralizer, the stop collar abuts and circumferentially engages the centralizer 2 to limit movement of the centralizer in one direction, and with movement of the centralizer in the opposite direction, it any engage the opposing stop collar to limit movement of the centralizer in the other direction.

Stop collars must be secured to the casing to the resist substantial forces that occur as the casing string is run into the borehole to its targeted depth. Centralizers may engage borehole restrictions or irregularities resulting in large forces urging the centralizer off its sets position on the casing string. Set screws are widely used to secure a stop collar to the casing string. Set screws are generally elongated shafts for being received into radially aligned holes drilled in the stop collar. Mating threads within the hole in the stop collar and along the shaft of the set screw provide a means of dispensing the set screw radially inwardly to contact and bear against the external wall of the casing by rotation of the screw within the threaded hole. The set screw rotates to advance the shaft radially inwardly to contact the external wall of the casing, and the set screw may be rotated further to “bite” into the casing and secure the stop collar onto the casing segment.

Set screws perform poorly where the pipe on which the stop collar is secured is very hard metal. The hardness prevents the set screw from sufficiently biting into the pipe to secure the stop collar. Set screws have other significant shortcomings as the diameter of the casing increases because of variations in standard casing diameter sizes. These size variations, which are acceptable within a certain range, substantially increase the likelihood of having a loose fit between the stop collar and the casing. A stop collar having a loose fit may need repositioning or rotation on the casing segment to ensure that the set screw will contact and “bite” into the wall of the casing upon rotation of the set screw. However, elastic deformation of stop collars is greater with large diameter sleeves, and full deployment of the set screw may not provide sufficient contact with the casing to reliably secure the stop collar and the centralizer at the selected position on the casing.

What is needed is a stop collar that can be reliably secured in place on a large diameter segment of casing to prevent unwanted movement of a centralizer along the length of the casing. What is needed is a method of securing a stop collar that promotes uniform casing stand-off and favorable cement placement by preventing centralizer movement during casing string installation.

### SUMMARY OF THE PRESENT INVENTION

The centralizer stop collar of the present invention provides improved securing of centralizers at selected locations on casing strings that are made up and run into boreholes. The centralizer stop collar of the present invention is adapted to be received and secured onto the outside of a segment of casing using epoxy adhesive. The centralizer stop collar is designed to form an annular chamber between the interior bore of the sleeve and the external surface of the casing segment received within the sleeve. The stop collar is adapted with apertures for facilitating the filling of the annular chamber with epoxy adhesive in a liquid gel phase, and for retaining the epoxy adhesive within the annular chamber until it cures or sets. The resulting elongated and circumferential bond between the stop collar and the casing segment provides superior securing of the stop collar as compared to the limited point contact obtained with set screws.

### BRIEF DESCRIPTION OF THE DRAWINGS

A more particular description of embodiments of the present invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a perspective view of a prior art centralizer of the type that may be secured in place on a casing segment using a stop collar.

FIG. 2 is a perspective side view of one embodiment of the centralizer stop collar of the present invention.

FIG. 3 is a perspective end view of one embodiment of the centralizer stop collar of the present invention.

FIG. 4A is a partial cross-section side view of one embodiment of the centralizer stop collar of the present invention received on a casing segment to form an annular chamber and coupled to a source of epoxy for filling the annular chamber.

FIG. 4B is a partial cross-sectional side view of one embodiment of the centralizer stop collar of the present invention received on a casing segment to form an annular chamber that is filled with epoxy.

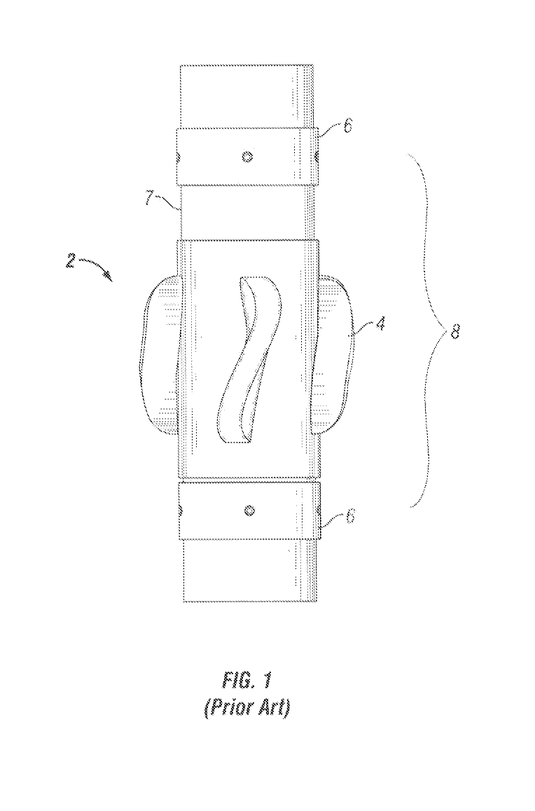

### DETAILED DESCRIPTION OF THE PRESENT INVENTION

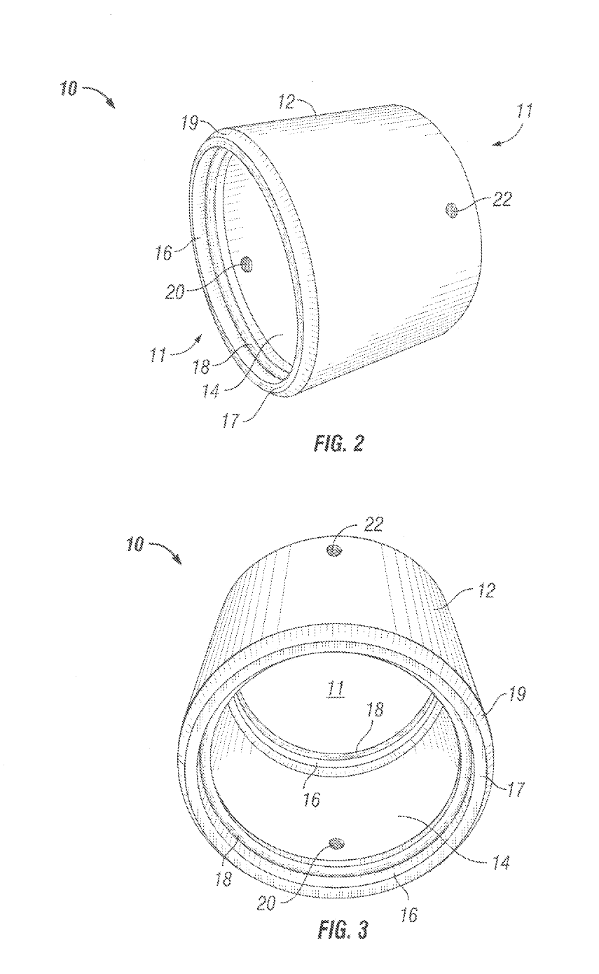

FIG. 2 is a perspective side view of one embodiment of the centralizer stop collar 10 of the present invention having a center bore 11 for receiving a casing segment, an external wall 12 and an internal wall 14. The openings 16 disposed at the ends of the bore 11 are of a slightly smaller diameter than the interior portion of the bore 11 along the internal wall 14 between the openings 16. This interior portion forms an annular chamber around the casing and within the stop collar 10 between the openings 16 when a casing segment (not shown) is received within the bore 11.

A circumferential landing 17 is disposed around each opening 16. The landing 17 is generally perpendicular to the axis of the bore 11, and is adapted for abutting contact with a moving collar of a centralizer (not shown). The opening 16 is adapted for receiving and securing an O-ring 18 to form a seal between the opening 16 and the external wall of the casing (not shown) received within the bore 11.

The stop collar comprises two apertures 20, 22. The apertures are preferably located near opposite openings 16 of the stop collar 10, and are preferably located one opposite the other across the bore 11 of the stop collar for reasons that are discussed below.

FIG. 3 is a perspective end view of one embodiment of the centralizer stop collar 10 of the present invention. The end view shows the opposing openings 16 and O-rings 18, and more of the internal wall 14 of the stop collar 10 than is shown in FIG. 2. FIG. 3 also shows the stop collar 10 in its orientation for being received onto a casing segment with aperture 20 located at the bottom of the sleeve 10 and the opposing aperture 22 positioned at the top of the sleeve 10.

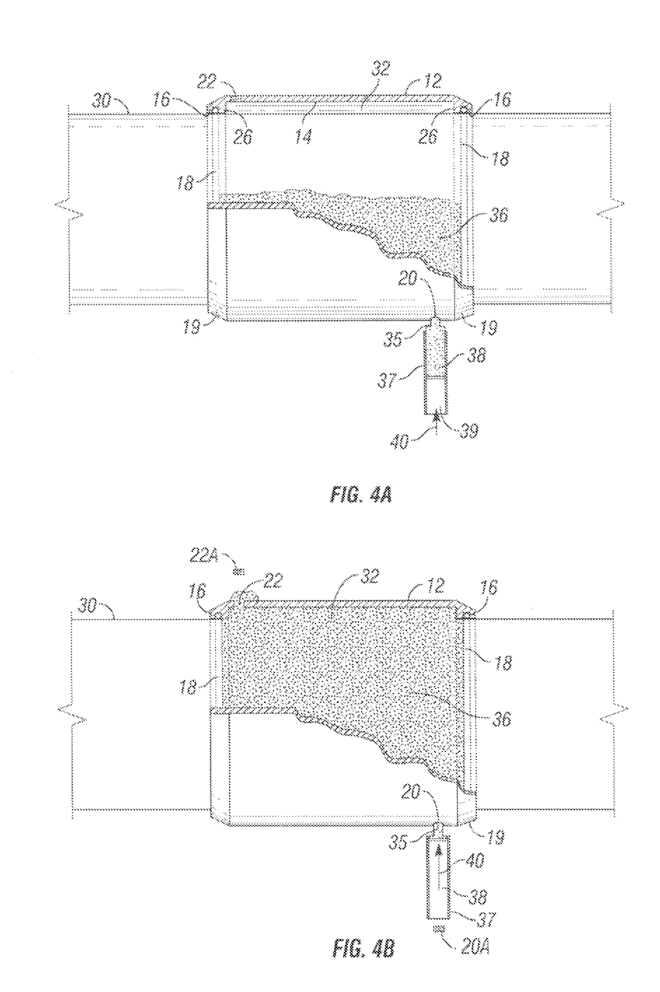

FIG. 4A is a partial cross-sectional side view of one embodiment of the centralizer stop collar 10 of the present invention rotationally oriented as shown in FIG. 3 and received onto a casing segment 30 to form an annular chamber 32. Aperture 20 receives a discharge 35 of an elongated tube 37 having a plunger 39 received therein for displacing a volume of liquid gel epoxy from a chamber 38 through the discharge 35 into annular chamber 32. A predetermined volume of epoxy is disposed within the chamber 38 sufficient for filling the annular chamber 32.

FIG. 4B is a partial cross-sectional side view of the embodiment of the centralizer stop collar 10 of FIG. 3A received on casing segment 30 to form an annular chamber 32 that has been filled with epoxy by displacement of the plunger 39 in the direction of arrow 40. Excess epoxy is displaced from the annular chamber 32 at aperture 22 to indicate that the annular chamber 32 is substantially filled with epoxy. Closure plug 22A is threadably receivable to close aperture 22 and, after removal of the discharge 35 from the opposing aperture 20, closure cap 20A is threadably receivable to close inferior aperture 20 to isolate the chamber 32 for curing of the epoxy.

Returning to FIGS. 2 and 3, internal wall 14 may be mechanically or chemically treated to enhance securing of the stop collar 10 onto the casing segment. For example, the internal wall 14 may be brushed, knurled, shot-peened, finned or otherwise textured or roughened to increase the surface area and the resulting bonding effect of the epoxy after it cures. Similarly, the internal wall 14 may be treated with an accelerant or other chemical to promote bonding of the epoxy the surface of the internal wall 14.

It should be noted that the present invention is equally useful with centralizers having spiral ribs as it is to those having ribs that are longitudinally aligned with the bore made of any suitable high strength material including, but not limited to, metal, plastic, fiberglass, composites, aluminum or aluminum alloys, brass, copper, zinc or zinc alloys.

In conclusion, therefore, it is seen that the present invention and the embodiments disclosed herein and those covered by the appended claims are well adapted to carry out the objectives and obtain the benefits set forth above. Certain changes may be made in the subject matter without departing from the spirit and the scope of this invention. Changes are possible within the scope of this invention and it is intended that each element or step recited in any of the following claims is to be understood as referring to all equivalent elements or steps.

What is claimed is:

1. A method of securing a collar to the external wall of a pipe comprising:
forming a generally cylindrical collar having a bore and openings adapted for sealing with the external wall of a pipe received through the collar;
slidably receiving a pipe through the bore of the collar to form an annular chamber between the collar and the external wall of the pipe segment;
filling the annular chamber with epoxy to secure the collar on the pipe; and curing the epoxy.

2. The method of claim 1 further comprising:
mechanically conditioning the internal wall of the collar to increase surface area.

3. the method of claim 1 further comprising:
mechanically conditioning the external surface of the portion of the pipe onto which the collar is secured.

4. A method of securing a collar to the external wall of a pipe to secure a centralizer in position on the pipe comprising:
disposing a collar between a pair of opposed moving collars of a centralizer;
receiving a pipe within the bore of a collar to form an annular chamber; and
filling the annular chamber with epoxy.

5. The method of claim 4 further comprising allowing the epoxy to cure.

6. A collar for being secured on a pipe to limit movement of a centralizer comprising:
a collar having a bore between opposed openings, the openings having a diameter less than the diameter of the bore of the collar between the opening;
a first aperture for introducing epoxy into an annular chamber formed upon receipt of a pipe through the openings and the bore; and
a generally opposed second aperture for venting air from the annular chamber as epoxy is introduced into the annular chamber through the first aperture.

7. A collar for being secured on a pipe received through a bore in the collar comprising:
a generally cylindrical collar having a first opening, a second opening and a bore therebetween the first opening and the second opening each adapted to receive a seal for sealing with the external wall of a pipe when the pipe is received through the first opening, the bore and the second opening to form an annular chamber radially between the internal wall of the collar and the external wall of the pipe, and axially between the seals;
a first aperture through the collar located near the first opening and a second aperture located generally opposite the first aperture and near the second opening;
wherein orienting the first aperture downwardly and the second aperture upwardly enables the annular chamber to be filled through the first aperture with epoxy for securing the collar to the external wall of the pipe.

8. The apparatus of claim 7 further comprising threads in one or both of the first and second apertures for receiving a threaded member.
